(19) United States
(12) Patent Application Publication
(10) Pub. No.: US 2011/0170979 A1
(43) Pub. Date: Jul. 14, 2011

(54) FASTENER ASSEMBLY

(76) Inventors: Paul R. Gerst, Newport Beach, CA (US); John William Gerst, Chula Vista, CA (US); Paul Vernon Gerst, Laguna Niguel, CA (US)

(21) Appl. No.: 12/685,806

(22) Filed: Jan. 12, 2010

(51) Int. Cl. F16B 39/00

(52) U.S. Cl. 411/103

(57) ABSTRACT

A fastener assembly for fastening two or more members together, the assembly comprising: a binding fastener; a stabilizing joint having a joint longitudinal axis, a fastener face, a first member face, a joint aperture, a first joint lateral edge, a second joint lateral edge, a first joint end, and a second joint end; a first member having a joint face, a second member face, and a slot having a first slot lateral edge, a second slot lateral edge, a first slot end, and a second slot end, the slot having a slot width less than a slot length, the stabilizing joint being lockably engageable in the slot in a plurality of positions along a slot longitudinal axis; and a second member having a second member aperture longitudinal axis, a member face, a nut face, and a second member aperture.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to a fastener assembly for use in fastening two or more members together.

A variety of mechanical and structural art devices require the fastening of two or more component parts to one another for assembly. For example, many automotive parts (e.g., alternator, fan belt, wheel assemblies) are assembled and mounted by the use of a bolt threaded through a washer and nut combination. Frequently, the bolt is not properly aligned along a longitudinal or arcuate axis with the surface of one or more component parts during mounting, thereby resulting in a misaligned installation. Any degree of misalignment may result in some reduction of the operational life of the part as well as reduce its performance.

For example, most automobile alternator belts and fan belts are wound around a driver and driven pulleys. The driver and driven pulleys in turn are powered by a driver and driven shaft. The drive shaft of alternators and fan belts are typically mounted by way of a threaded bolt, washer and nut combination. Misalignment of the driver pulley and/or drive shaft by as little as a quarter degree or more could result in the misalignment of the alternator belt at the time of installation, thereby reducing its own operational life and performance as well as that of other components of an automobile engine such as the timing belt. An alternator belt may experience parallel misalignment due to the driver and driven pulleys on the driver and driven shafts being in different planes. This may result from a misaligned mounting of the driver and/or driven pulleys to the drive shafts. Likewise, the driver and driven pulleys may experience angular misalignment with the driver and driven shafts not being parallel. Given the small margin for error to achieve correct installation, it is not surprising that the misalignment of an alternator and/or fan belts of a vehicle is a common occurrence. Whether due to oversight by the technician installing the component part or due to the failure of a threaded bolt, washer and/or nut configuration, the drive shafts and/or pulleys on which the alternator and fan belts are secured may be misaligned, as discussed above, resulting in excessive and premature wear and tear of these parts. This could also impact the safe and dependable performance of these parts, should the drive shaft abruptly cease operation or if these parts should break. Likewise, an aftermarket or originally manufactured wheel cover plate may be mounted to a wheel bracket by way of a threaded bolt and nut combination. If the wheel cover plate is improperly aligned with the wheel bracket, either due to the bolt being incorrectly threaded through the nut or the wheel bracket not being positioned flush with the wheel cover plate, the wheel cover plate may be misaligned during mounting and installation. This could pose a safety risk in the operation of the vehicle should the cover plate disengage from the wheel bracket.

Accordingly, there appears to be a need in the mechanical and structural arts for a new fastener assembly which improves the alignment between two or more members fastened together, thereby increasing the efficiency of installation, performance, and longevity of component parts.

### BRIEF SUMMARY

According to an aspect of the present invention, there is provided a fastener assembly for use in fastening two or more members together. The fastener assembly comprises a binding fastener and a stabilizing joint. The stabilizing joint may have a joint longitudinal axis, a fastener face, and a first member face opposite the fastener face. The stabilizing joint may further include a joint aperture extending through the stabilizing joint alignable with the binding fastener along a joint aperture axis. The joint aperture may be sized and configured to receive the binding fastener. The stabilizing joint may further have a non-linear first joint lateral edge and an opposing non-linear second joint lateral edge. The stabilizing joint may further have a first joint end and an opposing second joint end. The fastener assembly may further have a first member defining a slot lateral axis and slot longitudinal axis disposed perpendicular to the slot lateral axis. The first member may have a joint face and a second member face opposing the joint face. The first member may further have a slot disposed through the first member having a non-linear first slot lateral edge and an opposing non-linear second slot lateral edge. The slot may further have a first slot end and an opposing second slot end sized and configured to receive the stabilizing joint. The first member may further have a slot width between the first slot lateral edge and the second slot lateral edge that may be less than a slot length between the first slot end and the second slot end. The stabilizing joint may be lockably engageable between the first slot lateral edge and the second slot lateral edge in a plurality of positions along the slot longitudinal axis in the slot. The fastener assembly may further include a second member having a second member aperture longitudinal axis. The second member may have a member face and a nut face opposite the member face. The second member may further have a second member aperture extending through the second member aligned with the binding fastener along the second member aperture longitudinal axis. The member aperture may be sized and configured to receive the binding fastener.

The fastener assembly is innovative in that the complimentary configuration of the stabilizing joint and the first member uniquely enable the fastener assembly to properly align a first member fastened to a second member through the stabilizing joint by enabling the stabilizing joint to be adjusted along the slot longitudinal axis into a plurality of positions. The fastener assembly may thereby account for misalignment that may otherwise occur between the first member and the second member at the time the binding fastener is disposed through the first member and the second member, respectively. Using an automotive example, with the first member being a base plate and the second member being a bracket, a stabilizing joint may be moved along a slot longitudinal axis of the drive shaft to allow adjustment of the bracket. The ability to adjust the position of the pulley/shaft assembly by adjusting the position of the bracket may prevent the parallel misalignment of the driver and driven pulleys and the driver and driven shaft. Likewise, the adjustment of the stabilizing joint along the slot longitudinal axis of the first member may prevent angular misalignment with the driver and driven shafts not being parallel to each other. The fastener assembly is therefore able to adjust the positioning of the first member such that it is properly aligned with the second member when the binding fastener is received through the joint aperture of the stabilizing joint and the member aperture of the second member. The fastener assembly may similarly enable the proper adjustment of a fan belt to the fan belt pulley by movement of the stabilizing joint along a slot longitudinal axis. Also, a wheel cover plate may be properly aligned to a cover plate bracket by adjusting the position of the stabilizing joint along the slot longitudinal axis to enable proper alignment. It is contemplated that the claimed assembly may be applied to a variety of mechanical parts or devices having two or more members that are sought to be aligned and fastened to one another.

In another embodiment, the fastener assembly may further include a threaded nut having a nut aperture. The binding fastener may be slidably disposable through the threaded nut. In an alternative embodiment, the second member aperture of the second member may be threaded.

According to other embodiments of the present invention, the binding fastener may have a hexagonal head.

In a further embodiment, the fastener assembly may also include a washer disposed between the binding fastener and the fastener face of the stabilizing joint.

In another embodiment, the non-linear first joint lateral edge of the stabilizing joint may have one or more serrated teeth. In another embodiment, the non-linear second joint lateral edge may also have one or more serrated teeth. The non-linear first slot lateral edge may have one or more serrated teeth complimentary to the serrated teeth of the first joint lateral edge. The non-linear second joint lateral edge may also have one or more serrated teeth complementary to the serrated teeth of the second joint lateral edge.

According to another embodiment, the non-linear first joint lateral edge of the stabilizing joint may have one or more arcuate teeth. In another embodiment, the non-linear second joint lateral edge may have one or more arcuate teeth. The non-linear first slot lateral edge may have one or more arcuate teeth complimentary to the arcuate teeth of the first joint lateral edge. In a further embodiment, the non-linear second slot lateral edge may have one or more arcuate teeth complementary to the arcuate teeth of the second joint lateral edge.

In yet a further embodiment of the present invention, the first joint end of the stabilizing joint may be arcuate. In a further embodiment, the second joint end may be arcuate. In another embodiment, the first slot end may be arcuate and complementary to the first joint end. According to another embodiment, the second slot end may be arcuate and complementary to the second joint end. According to another embodiment, the threaded nut may be hexagonal.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a top view of the fastener assembly depicting the binding fastener disposed through the washer, stabilizing joint, first member and second member, with the first slot lateral edge having serrated teeth complementary to the first joint lateral edge, and the second slot lateral edge having serrated teeth complementary to the second joint lateral edge.

FIGS. 1A and 1B are perspective views of an exemplar pulley/shaft assembly implementing the fastener assembly.

FIG. 2 is a perspective view of the fastener assembly depicting the slot in the first member in which the stabilizing joint may be variously positioned along a slot longitudinal axis.

FIG. 3 is a cross-sectional perspective view of the various components of the fastener assembly, with the binding fastener shown to be disposable through the washer, stabilizing joint, first member, second member, and a threaded nut, the first and second edges of the stabilizing joint and first member being complementary to each other.

FIG. 4 is a top view of the fastener assembly with the stabilizing joint positioned proximate to the first slot end the stabilizing joint having serrated edges complementary to the first slot end of the first member.

FIG. 5 is a cross-sectional view of the fastener assembly with the stabilizing joint positioned proximate to the first slot end of the first member.

FIG. 6 is a top view of the fastener assembly with the stabilizing joint positioned proximate to the first slot end, the arcuate edges of the slot being complementary to the stabilizing joint.

### DETAILED DESCRIPTION

The drawings referred to herein are for the purposes of illustrating the preferred embodiments of the present invention and not for the purposes of limiting the same.

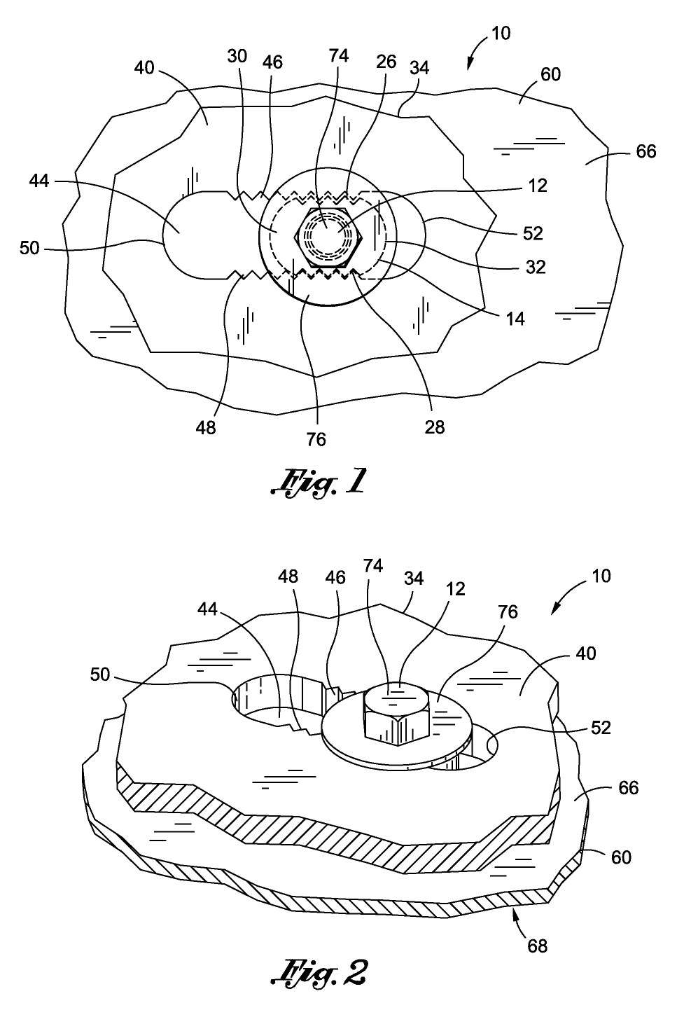

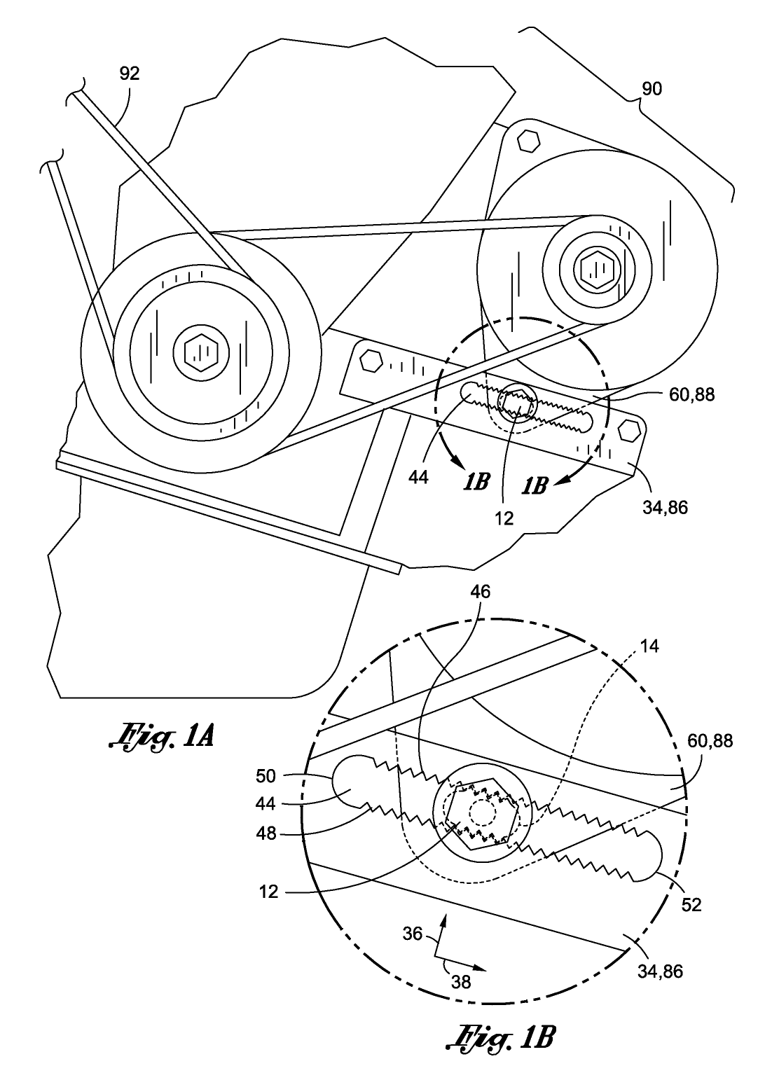

FIG. 1 is an embodiment of the fastener assembly 10 having a hexagonal head 74 on the binding fastener 12. The stabilizing joint 14 has a non-linear first joint lateral edge 26 and a non-linear second joint lateral edge 28. The stabilizing joint 14 further has a first joint end 30 and a second joint end 32. In this embodiment, the non-linear first joint lateral edge 26 and the non-linear second joint lateral edge 28 have a plurality of serrated teeth 78. In another embodiment as shown in FIG. 6, the non-linear first joint lateral edge 26 and the non-linear second joint lateral edge 28 may have a plurality of arcuate teeth 80. However, it is also contemplated within the scope of the present invention that the various aspects of the fastener assembly 10 may be employed with a non-linear first joint lateral edge 26 and a non-linear second joint lateral edge 28 having a polygonal or other configuration that are complimentary to the non-linear first slot lateral edge 46 and the non-linear second slot lateral edge 48 of the slot 44 on the first member 34. Again referring to FIG. 1, the stabilizing joint 14 may be moved into a plurality of positions along the slot longitudinal axis 38 of the slot 44. This enables an adjustment in the position of the first member 34 relative to the second member 60. This feature in turn uniquely enables the stabilizing joint 14 to correct for any misalignment that may occur between the first member 34 and the second member 60 with the binding fastener 12 being disposed through the joint aperture 24 and the member aperture 70.

As discussed above, the non-linear first joint lateral edge 26 and the non-linear second joint lateral edge 28 of the stabilizing joint 14 are complimentary to the non-linear first slot lateral edge 46 and the non-linear second slot lateral edge 48 of the slot 44, thereby enabling the stabilizing joint 14 to be moved into various positions along the slot longitudinal axis 38 of the first member 34. This configuration enables the position of the first member 34 to be adjusted such that it is aligned with the second member 60.

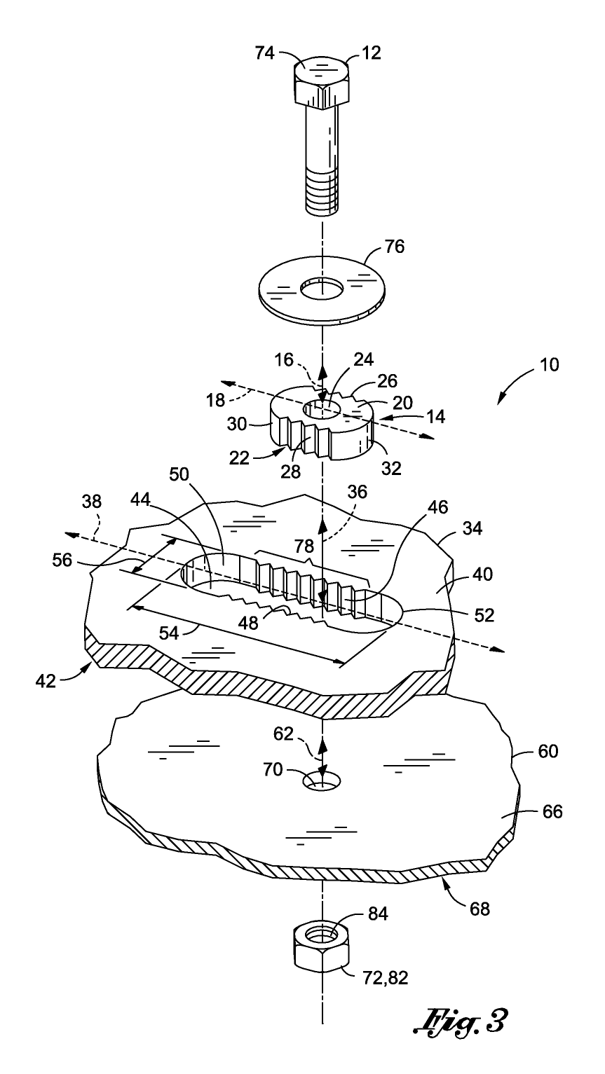

As shown in FIGS. 1-3, the slot 44 also has a first slot end 50 and second slot end 52. In the embodiment depicted in FIGS. 1 and 3, the first slot end 50 and the second slot end 52 are serrated, and are complementary to the first joint end 30 and the second joint end 32. This configuration uniquely enables the stabilizing joint 14 to be lockably engageable in a plurality of positions along the slot longitudinal axis 38 between the first joint end 30 and the second joint end 32 of the first member 34. As used herein, the term “lockably engageable” means the engagement of the first 26 and second joint edge 28 of the stabilizing joint 14 to the first 46 and second slot edge 48 of the first member 34 in a locked position that prevents the stabilizing joint 14 from moving in either direction along the plane of the slot longitudinal axis 38. The “locked engagement” of the stabilizing joint 14 to the first member 34 does not prevent the movement of the stabilizing joint 14 in directions other than the plane of the slot longitudinal axis 38. As discussed above, it is also contemplated within the scope of the present invention that the various aspects of the fastener assembly 10 may be employed with a non-linear first slot lateral edge 46 and a non-linear second slot lateral edge 48 that has a polygonal or other configuration that is complementary to the non-linear first joint lateral edge 26 and the non-linear second joint lateral edge 28 of the stabilizing joint 14. The embodiment of the fastener assembly depicted in FIG. 3 has a slot 44 on the first member 34 having a slot width 56 between the first slot lateral edge 46 and the second slot lateral edge 48 that is less than a slot length 54 between the first slot end edge 50 and the second slot end 52. This configuration uniquely enables the stabilizing joint 14 to be lockably engaged between the first slot lateral edge 46 and the second slot lateral edge 48 in a plurality of positions along the slot longitudinal axis 38 in the slot 44. The stabilizing joint 14 may also have a joint aperture 24 through which the binder fastener 12 may be disposed. The joint aperture 24 may be alignable with the binding fastener 12 along a joint aperture axis 16.

Still referring to FIG. 3, the stabilizing joint 14 may further have a joint longitudinal axis 18 generally perpendicular to the joint aperture axis 16. The stabilizing joint 14 may further have a fastener face 20 facing the binding fastener 12 and an opposing first member face 22 facing the first member 34. A washer 76 may be disposed between the binding fastener 12 and the stabilizing joint 14. The slot 44 defines a slot longitudinal axis 38 perpendicular that is generally perpendicular to the slot lateral axis 36. With the binding fastener 12 disposed through the joint aperture 24 and the stabilizing joint 14 aligned with the joint aperture 24 along the joint aperture axis 16, the slot lateral axis 36 may be concentric to and a continuum of the joint aperture axis 14. The position of the slot lateral axis 36 and the joint aperture axis 16 will change with the adjustment of the stabilizing joint 14 along the slot longitudinal axis 38. The first member 34 may have a joint face 40 facing the stabilizing joint 14 and a second member face 42 facing the second member 60. In one embodiment, the second member 60 may have a member face 66 facing the first member 34 and a nut face 68 facing a threaded nut 82. The threaded nut 72 may have a nut aperture 84. The second member 60 has a second member aperture 70 through which the binding fastener 12 may be disposed along a second member aperture longitudinal axis 62. The joint aperture axis 14 may be concentric to and a continuum of the second member aperture longitudinal axis 62 with the binding fastener 12 disposed through the second member aperture 70. In one embodiment of the fastener assembly 10, the second member aperture 70 may be threaded. The binding fastener 12 may also be further disposed through a nut aperture 84 positioned beneath the second member 60 in another embodiment of the fastener assembly 10.

The fastener assembly 10 uniquely accounts for misalignment that may otherwise occur between the first member 34 and the second member 60 with the binding fastener 12 disposed and threaded through the joint aperture 24 and the second member aperture 70, respectively. By enabling the stabilizing joint 14 to be adjusted along the slot longitudinal axis 38 of the first member 34 into a plurality of positions, the first member 34 and the second member 60 may be aligned with the binding fastener 12 disposed through the first member 34 and the second member 60.

The fastener assembly 12 may be applied to a variety of mechanical art devices having two or more members or component parts that require fastening or fixation to one another. For example, as shown in FIGS. 1A and 1B, the first member 34 may be a base plate 86. The second member 60 may be a bracket 88 attached to a pulley/shaft assembly 90 with a timing belt 92. The application of the fastener assembly 10 to the base plate 86 and bracket 88 of the pulley/shaft assembly 90 may enable a stabilizing joint 14 to be moved along a slot longitudinal axis 38 in the slot 44 of the base plate 86 to adjust for any potential misalignment. The ability to adjust the position of the bracket 88 along a slot longitudinal axis 38 may prevent the parallel misalignment of the driver and driven pulleys from the driver and driven shafts of the pulley/shaft assembly 90. Likewise, the ability to adjust the stabilizing joint 14 in the slot 44 along the slot longitudinal axis 38 of the base plate 86, thereby allowing adjustment of the underlying bracket 88 to align with the base plate 86, may prevent angular misalignment between the driver and driven shafts of the alternator belt in the pulley/shaft assembly 90. These same beneficial aspects of the fastener assembly 10 may similarly also have application to fan belt drives having a fan belt shaft and fan belt pulley, wheel cover plates mounted to a wheel cover plate bracket, and wheel axles mounted to a wheel. It is contemplated within the scope of the present invention that the various aspects of the fastener assembly 10 may be applied to a variety of mechanical arts and other devices comprising a first member and a second member that are sought to be aligned and fastened with one another for assembly or installation. The application of the fastener assembly 10 to the pulley/shaft assembly 88 of a timing belt, or a fan belt or to a wheel cover plate, amongst others may be an improvement in the performance and longevity of these parts by allowing for correction in their alignment at the time of installation.

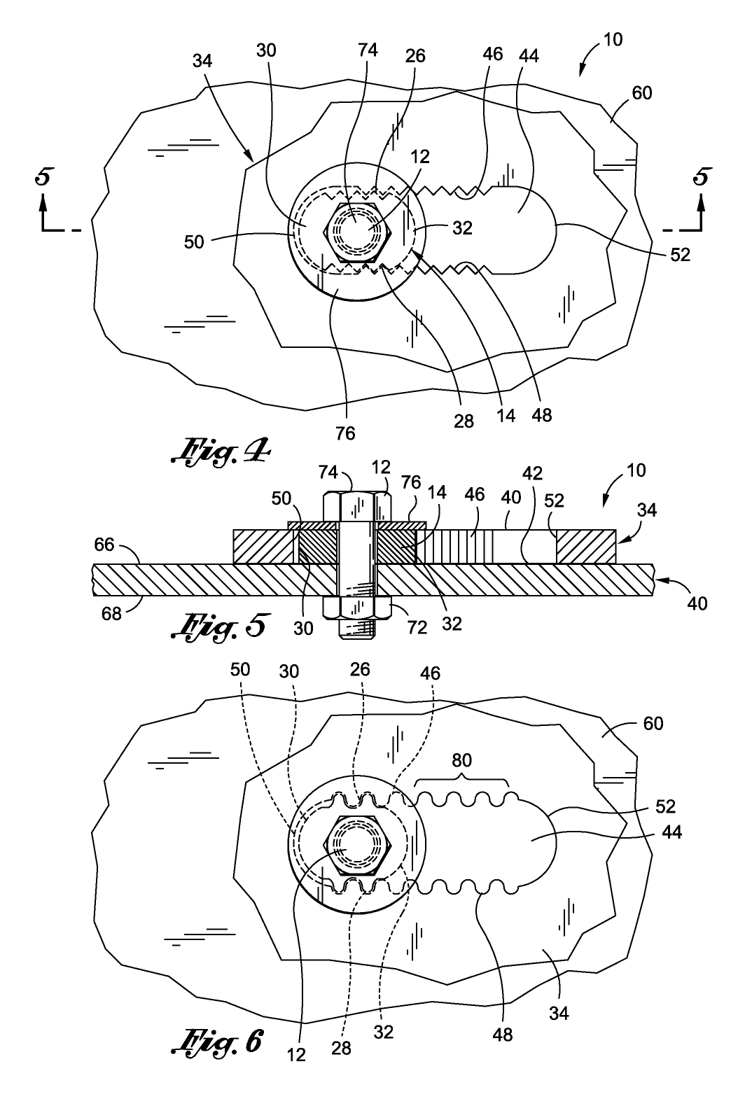

FIGS. 4-6 depict an embodiment of the fastener assembly 10 with the first joint end 30 of the stabilizing joint 14 disposed proximate to the first slot end 50 of the first member 34. In like fashion, the stabilizing joint 14 may be adjusted along the slot longitudinal axis 38 of the first member 34 such that the second joint end 32 is positioned proximate to the second slot end 52 of the first member 34. In the embodiment depicted in FIGS. 4 and 6, the first joint end 30 and the second joint end 32, and the first slot end 50 and the second slot end 52 are complementarily arcuate. However, it is also contemplated within the scope of the present invention that the various aspects of the fastener assembly 10 may be employed with a first joint end 30, a second joint end 32 that has a linear, polygonal, or any other configuration that is complementary to the first slot end 50 and the second slot end 52 of the slot 44 on the first member 34.

What is claimed is:

1. A fastener assembly for use in fastening two or more members together, the assembly comprising:
a binding fastener;
a stabilizing joint having a joint longitudinal axis, a fastener face, a first member face opposite the fastener face, and a joint aperture extending through the stabilizing joint alignable with the binding fastener along a joint aperture axis, the joint aperture being sized and configured to receive the binding fastener, the stabilizing joint further having a non-linear first joint lateral edge, an opposing non-linear second joint lateral edge, a first joint end, and an opposing second joint end;
a first member defining a slot lateral axis and a slot longitudinal axis disposed perpendicular to the slot lateral axis, the first member having a joint face, a second member face opposite the joint face, and a slot disposed through the first member having a non-linear first slot lateral edge, an opposing non-linear second slot lateral edge, a first slot end, and an opposing second slot end sized and configured to receive the stabilizing joint therein, the first member further having a slot width between the first slot lateral edge and the second slot lateral edge being less than a slot length between the first slot end and the second slot end, the stabilizing joint further being lockably engageable between the first slot lateral edge and the second slot lateral edge in a plurality of positions along the slot longitudinal axis in the slot;
a second member having a second member aperture longitudinal axis, the second member further having a member face, a nut face opposite the member face, and a second member aperture extending through the second member alignable with the binding fastener along the second member aperture longitudinal axis, the second member aperture being sized and configured to receive the binding fastener.

2. The assembly as claimed in claim 1 further includes a threaded nut having a nut aperture, the binding fastener being slidably disposable through the threaded nut.

3. The assembly as claimed in claim 1 wherein the second member aperture is threaded.

4. The assembly as claimed in claim 1, wherein the binding fastener has a hexagonal head.

5. The assembly as claimed in claim 1 further includes a washer disposed between the binding fastener and the fastener face of the stabilizing joint.

6. The assembly as claimed in claim 1, wherein the non-linear first joint lateral edge has one or more serrated teeth.

7. The assembly as claimed in claim 6, wherein the non-linear second joint lateral edge has one or more serrated teeth.

8. The assembly as claimed in claim 6, wherein the non-linear first slot lateral edge has one or more serrated teeth complementary to the first joint lateral edge.

9. The assembly as claimed in claim 7, wherein the non-linear second slot lateral edge has one or more serrated teeth complementary to the second joint lateral edge.

10. The assembly as claimed in claim 1, wherein the non-linear first joint lateral edge has one or more arcuate teeth.

11. The assembly as claimed in claim 10, wherein the non-linear second joint lateral edge has one or more arcuate teeth.

12. The assembly as claimed in claim 10, wherein the non-linear first slot lateral edge has one or more arcuate teeth complementary to the first joint lateral edge.

13. The assembly as claimed in claim 12, wherein the non-linear second slot lateral edge has one or more arcuate teeth complementary to the second joint lateral edge.

14. The assembly as claimed in claim 1, wherein the first joint end is arcuate.

15. The assembly as claimed in claim 14, wherein the second joint end is arcuate.

16. The assembly as claimed in claim 14, wherein the first slot end is arcuate and complementary to the first joint end.

17. The assembly as claimed in claim 15, wherein the second slot end is arcuate and complementary to the second joint end.

18. The assembly as claimed in claim 2, wherein the threaded nut is hexagonal.
